(19) United States
(12) Patent Application Publication
(10) Pub. No.: US 2008/0025307 A1
(43) Pub. Date: Jan. 31, 2008

(54) SYSTEM AND METHOD FOR PUSHING INFORMATION FROM A SOURCE DEVICE TO AN AVAILABLE DESTINATION DEVICE

(75) Inventors: Bruno R. Preiss, Waterloo (CA); Giyeong Son, Mississauga (CA); Allan Lewis, New Dundee (CA)

Correspondence Address: RIDOUT & MAYBEE;SUITE 2400, ONE QUEEN STREET EAST, TORONTO, ON, M5C3B1, US

(73) Assignee: RESEARCH IN MOTION LIMITED, Waterloo (CA)

(21) Appl. No.: 11/460,295

(22) Filed: Jul. 27, 2006

(51) Int. Cl. H04L 12/56

(52) U.S. Cl. 370/392; 370/401

(57) ABSTRACT

A method is provided for delivering data from a source device to one of a plurality of destination devices. The method includes the steps of accepting identification of a user of the plurality of destination devices and accepting data to be sent to the user; transferring the user identification and the data to a server responsible for delivering the data to the user; retrieving preference data defining prioritization rules for the delivery of the data to one of the plurality of destination devices; retrieving presence data reporting the availability of each of the plurality of destination devices for receiving the data; selecting which of the plurality of destination devices to deliver the data to based on the presence data and the preference data; and delivering the data to the selected destination device.

### FIELD OF THE INVENTION

The present application relates generally to mobile electronic devices and, more specifically, to a system and method for pushing information from a source to an available one of a plurality of destination devices.

### BACKGROUND OF THE INVENTION

As technology proliferates and people collect digital devices such as cellular phones, personal digital assistants, personal computers, and other devices, simultaneously managing the information flow on all of these devices becomes a burden for both the user of the devices, as well as others who may be trying to contact the user. In some cases, a client or co-worker may attempt to contact a person by email while the person is inaccessible by email but accessible by cellular phone. In other cases, a client or co-worker may attempt to contact the person by phone while the person is inaccessible by phone but is using a computer and is instantly accessible via an instant messaging application. Even though a person may be accessible by a means of communication, current methods of communication do not guarantee that co-workers will be able to connect with the person. For time critical messages, the juxtaposition of technology that users are currently forced to deal with can have severe adverse consequences. Additionally, trying to figure out the most effective way to contact a person at a particular time of day is a waste of time that is better spent on other activities.

Accordingly, there remains a need for improvements to be made to how digital devices interact with each other and how information is delivered to digital devices, and there is a need for mediation between the various services supplying information to the digital devices.

### BRIEF DESCRIPTION OF THE DRAWINGS

Reference will now be made to the drawings, which show by way of example, embodiments of the invention, and in which:

FIG. 1 shows in block diagram form a communication system suitable for pushing information from a source device to an available destination device in accordance with one embodiment;

FIG. 2 shows in diagrammatic form a mobile electronic device suitable for running a client application for pushing information to an available destination device in accordance with one embodiment;

FIG. 3 shows in block diagram form one embodiment of a network configuration for pushing information from a source device to an available destination device in accordance with one embodiment; and

FIG. 4 shows in flow chart form a method for pushing information from a source device to an available destination device in accordance with one embodiment.

In the drawings, like reference numerals denote like elements or features.

### DETAILED DESCRIPTION OF THE EMBODIMENTS

In one embodiment, a system is provided for use with a source device that accepts data from a user. The system pushes the data from the source device to one of a plurality of destination devices used by a target user and accessible to the system. The system comprises a push server component communicating with the source device over a first network connection and communicable with the plurality of destination devices over respective second networks, where the global push server component has a number of modules including: (a) a delivery module for coordinating delivery of the data to one of the plurality of destination devices that is available for receiving the data; (b) a presence module interfacing with the delivery module for retrieving over the respective second networks presence information about the plurality of destination devices and informing the delivery module which of the destination devices is available for receiving the data; (c) a preference and data module interfacing with the delivery module for storing delivery prioritization data for the plurality of destination devices and informing the delivery module of a predetermined delivery prioritization for the plurality of destination devices; and (d) a translation module interfacing with the delivery module for translating the data into a form receivable by a selected one of the plurality of destination devices.

In another embodiment, a method is provided for delivering data from a source device to one of a plurality of destination devices. The method includes the steps of accepting identification of a user of the plurality of destination devices and accepting data to be sent to the user; transferring the user identification and the data to a server responsible for delivering the data to the user; retrieving preference data defining prioritization rules for the delivery of the data to one of the plurality of destination devices; retrieving presence data reporting the availability of each of the plurality of destination devices for receiving the data; selecting which of the plurality of destination devices to deliver the data to based on the presence data and the preference data; and delivering the data to the selected destination device.

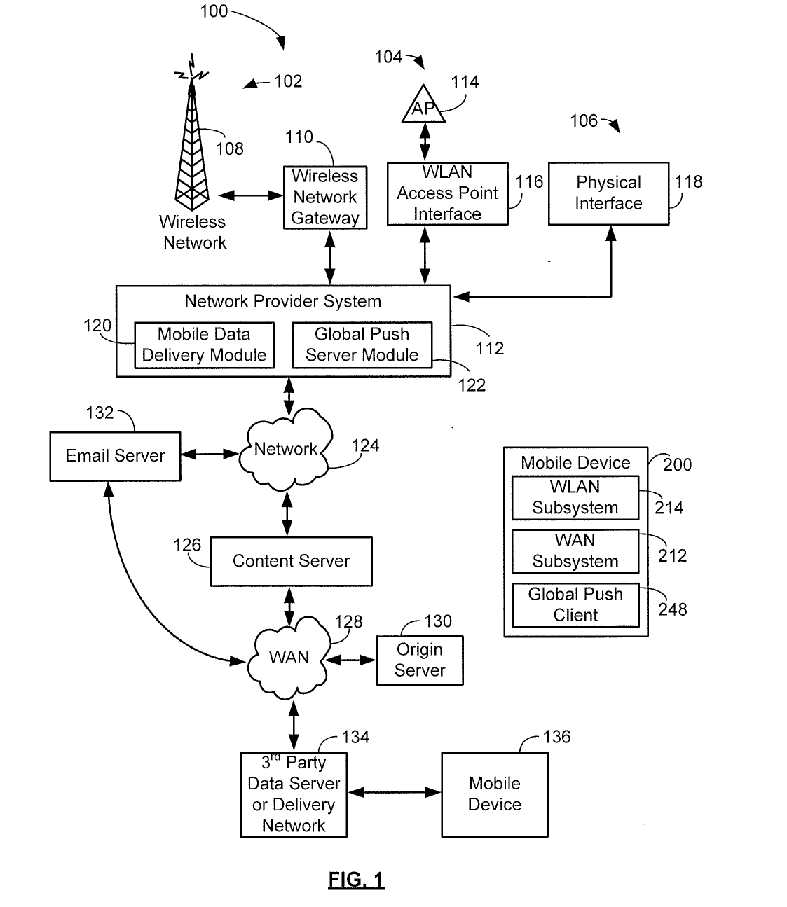

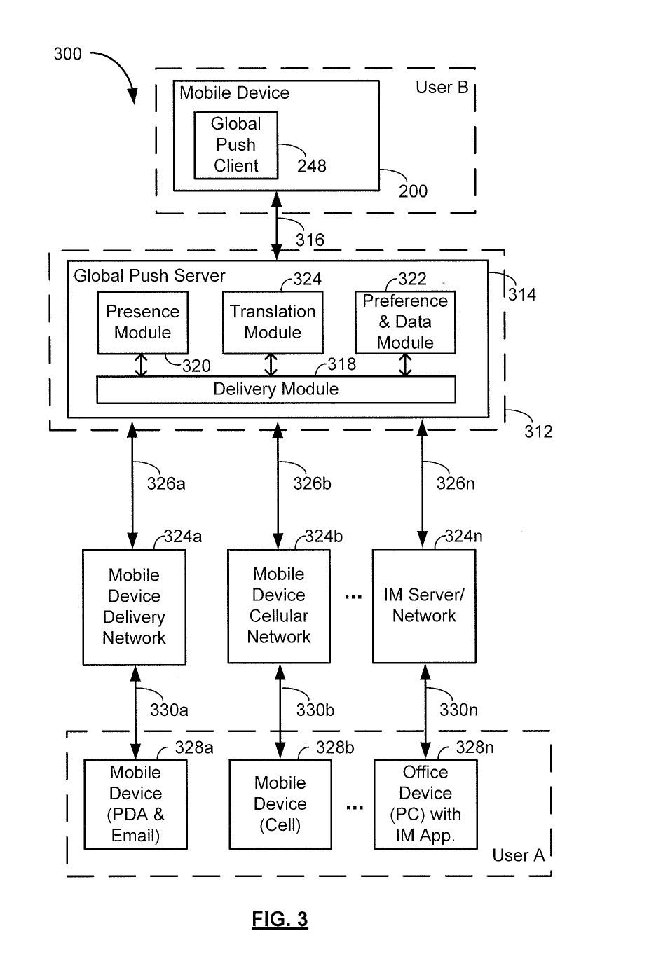

Reference is first made to FIG. 1, which shows a communication system 100 suitable for application to a system and method for pushing information from a source device to an available destination device. The system 100 illustrates a general communications system 100 applicable to the detailed architecture described in more detail in connection with FIG. 3 below. The communication system 100 generally includes one or more mobile electronic devices 200 (only one of which is shown in FIG. 1), a wireless Wide Area Network (WAN) 102, a Wireless Local Area Network (WLAN) 104, and/or other interfaces 106.

Referring to FIG. 1, the wireless WAN 102 may be implemented as a packet-based cellular network that includes a number of base stations 108 (one of which is shown in FIG. 1) where each of the base stations 108 provides wireless Radio Frequency (RF) coverage to a corresponding area or cell. The wireless WAN 102 is typically operated by a cellular network service provider that sells subscription packages to users of the mobile electronic devices 200. The wireless WAN 102 comprises a number of different types of networks, for example, Mobitex Radio Network, DataTAC, GSM (Global System for Mobile Communication), GPRS (General Packet Radio System), TDMA (Time Division Multiple Access), CDMA (Code Division Multiple Access), CDPD (Cellular Digital Packet Data), iDEN (integrated Digital Enhanced Network) or various other third generation networks such as EDGE (Enhanced Data rates for GSM Evolution) or UMTS (Universal Mobile Telecommunications Systems).

As shown in FIG. 1, the communications system 100 also includes a wireless network gateway 110 and one or more network provider systems 112. The wireless network gateway 110 provides translation and routing services between the network provider system(s) 112 and the WAN 102 which facilitates communication between the mobile electronic devices 200 and other devices (not shown) connected, directly or indirectly, to the network provider system 112.

The WLAN 104 comprises a network which in some examples conforms to IEEE 802.11 standards such as 802.11b and/or 802.11g; however, other communications protocols may also be used for the WLAN 104. The WLAN 104 includes one or more wireless RF Access Points (AP) 114 (one of which is shown in FIG. 1) that collectively provide a WLAN coverage area. For the embodiment depicted in FIG. 1, the WLAN 104 is operated by an enterprise (for example, a business or university) and the access points 114 are connected to an access point (AP) interface 116. The AP interface 116 provides translation and routing services between the access points 114 and the network provider system 112 to facilitate communication between two or more of the mobile electronic devices 200 and other devices connected, directly or indirectly, to the network provider system 112. The AP interface 116 is implemented using a computer, for example, a server running a suitable computer program or software.

According to one embodiment, the other interfaces 106 may be implemented using a physical interface indicated by reference 118. The physical interface 118 includes an Ethernet, Universal Serial Bus (USB), Firewire, or infrared (IR) connection implemented to exchange information between the network provider system 112 and the mobile electronic device 200.

The network provider system 112 comprises a server or server modules or a number of servers or server modules which are located behind a firewall (not shown). In one embodiment, the network provider system 112 includes a number of modules including a mobile data delivery module 120 and a global push server module 122. In one embodiment, the various modules may be implemented as a number of services running on a single server or as a number of interconnected servers each running a software program to implement the functionality of the respective module. The network provider system 112 provides access for the mobile electronic devices 200, through either the wireless WAN 102, the WLAN 104, or the other connection 106 to the devices connected, for example, through an enterprise network 124 (e.g., an intranet), to the network provider system 112. In one embodiment, the data delivery module 120 and the global push server module 122 are implemented on a computer, such as the network provider system 112.

The enterprise network 124 comprises a local area network, an intranet, the Internet, a direct connection, or combinations thereof. According to one embodiment, the enterprise network 124 comprises an intranet for a corporation or other type of organization. In at least some example embodiments, the network provider system 112 is part of the enterprise network 124, and is located behind a corporate firewall and connected to the wireless network gateway 110 through the Internet. As shown in FIG. 1, an application/content server 126 may be connected to the enterprise network 124 and also to another network, for example a Wide Area Network (WAN), indicated by reference 128. In some embodiments, an email server 132 and/or the content server 126 form part of the enterprise network 124. The WAN 128 may further connect to other networks. In one embodiment, the WAN 128 comprises or is configured with the Internet, a direct connection, a LAN, a wireless communication link, or any combination thereof. Content providers, such as Web servers, may be connected to the WAN 128, an example of which is shown in FIG. 1 as an origin server, indicated by reference 130. Other devices or external networks may be connected to WAN 128 such as a third party data server or delivery network 134. The third party data server/delivery network 134 may be responsible for delivering content to/from specific mobile devices such as a mobile device 136. In one embodiment, the third party data server 134 may be a cellular phone provider network and the mobile device 136 may be a cellular phone. The WAN 128 may be connected to any number of third party servers and associated electronic devices. In one example configuration, the email server 132 is connected to the enterprise network 124 and the email server 132 is configured to direct or redirect email messages received over the WAN 128 and internally within the enterprise network 124 to be addressed to the mobile electronic device(s) 200. While the global push server module 122 is shown implemented in the network provider system 112, the global push server module 122 acts as as service mediator and may be implemented on any server within the system 100.

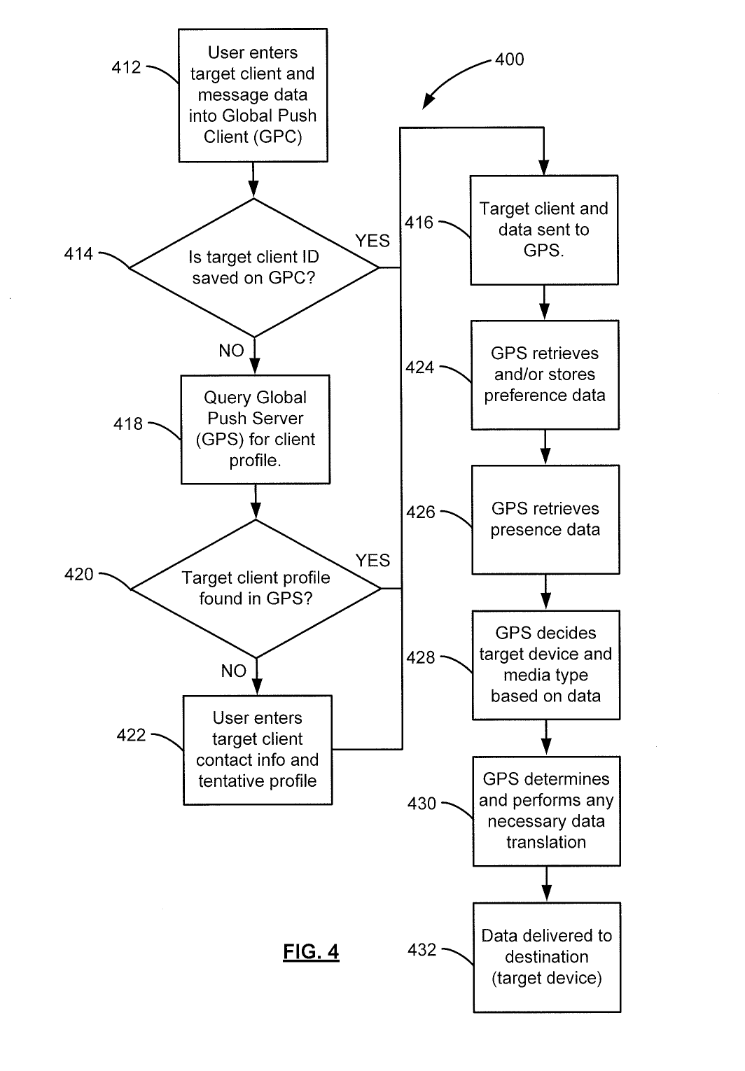

According to one embodiment, the mobile data delivery module 120 provides connectivity between the wireless WAN 102 and the WLAN 104 and the other connection 106 and devices and/or networks connected directly or indirectly to the network provider system 112. In one embodiment, the connectivity provided may be HTTP based connectivity providing an Internet based service connection to devices connected to the wireless WAN 102, the WLAN 104, or the other connection 106 and devices and/or networks connected directly or indirectly to the network provider system 112. The network 124, the application/content server 126, the WAN 128, and the origin server 130, are individually and/or collectively in various combinations a content source for the network provider system 112. It will be appreciated that the system shown in FIG. 1 comprises but one possible communication network or configuration of a multitude of possible configurations for use with the mobile electronic devices 200, the system described below in connection with FIG. 3, and the method described below in connection with FIG. 4.

The mobile electronic devices 200 are configured to operate, as described above with reference to FIG. 1, within the wireless WAN 102 and/or the WLAN 104. As shown in FIG. 1, the mobile electronic device 200 is configured with or includes a WAN communications subsystem 212 for communicating with the wireless WAN 102 and/or a WLAN communications subsystem 214 for communicating with the access points 114 of the WLAN 104. The mobile electronic device 200 also includes a global push client 248 for coordinating communications with the global push server module 122.

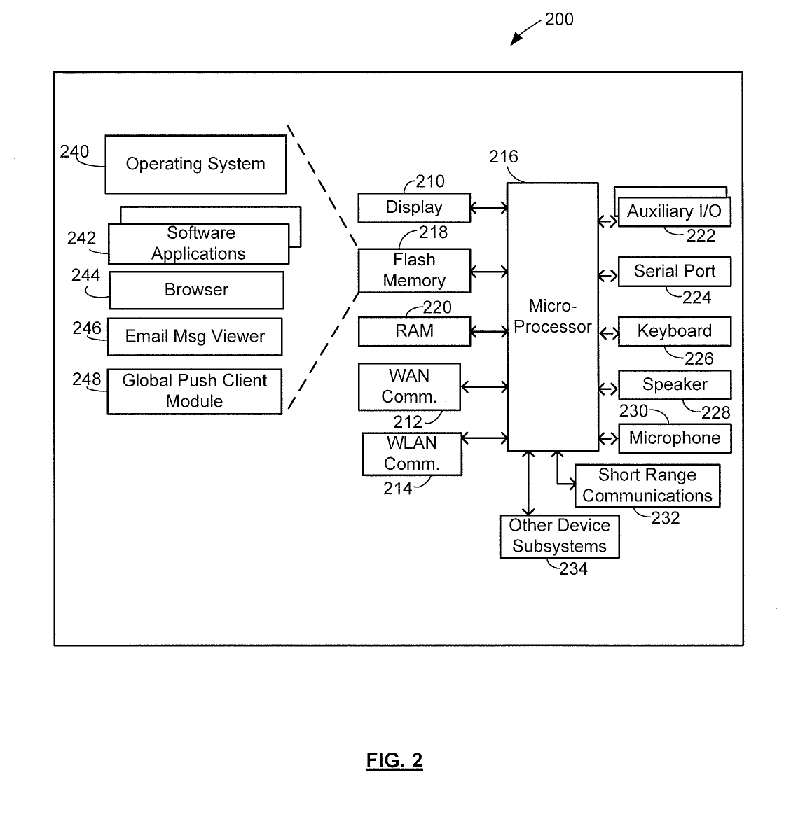

Reference is next made to FIG. 2, which shows an embodiment of the mobile electronic device suitable for application to a system and method for pushing information from a source device to an available destination device and is indicated generally by reference 200. The mobile electronic device 200 includes a display module 210, the wireless WAN communication subsystem 212 for two-way communications with the wireless WAN 102 (FIG. 1), and the WLAN communications subsystem 214 for two-way communications with the WLAN 104 (FIG. 1). According to one embodiment, the mobile electronic device 200 need not include both the wireless WAN communications subsystem 212 and the WLAN communications subsystem 214. The mobile electronic device may have either one or both of the wireless WAN communications subsystem 212 and the WLAN communications subsystem 214, depending on the design criteria of a particular application. According to one embodiment, the communications subsystems 212 and 214 include respective antennas (not shown), RF transceivers (not shown), and some signal processing capabilities, implemented, for example, by a digital signal processor (not shown). The mobile electronic device 200 also includes a microprocessor 216 which is suitably programmed to control the overall operation and functions of the mobile electronic device 200, which are described in more detail below. The mobile electronic device 200 includes peripheral devices or subsystems such as a flash memory 218, a random access memory (RAM) 220, an auxiliary input/output (I/O) subsystem 222 (e.g., an external communications link such as Ethernet), a serial port 224 (e.g., a USB port), an input device 226 (e.g., a keyboard or keypad), a speaker 228, a microphone 230, a short-range communications subsystem 232 (e.g., an infrared transceiver, wireless bus protocol such as a Bluetooth system, or any other means of local wireless communications), and any other device subsystems generally designated by reference 234.

The microprocessor 216 operates under stored program control with code or firmware being stored in the flash memory 218 (or other type of non-volatile memory device or devices). The flash memory 218 includes stored programs (e.g., firmware) including an operating system program or code module 240 and other programs or software applications indicated generally by reference 242. The software applications 242 for a Web-enabled embodiment or implementation of the mobile electronic device 200 comprise a Web browser 244 and an email message viewer 246. The software applications 242 for embodiments of the mobile electronic device 200 that include the ability to push information to an available destination device include the global push client module 248, for interacting with a server such as the global push server module 122 (FIG. 1). Each of the software applications 242 may include layout information defining the placement of particular fields, such as text fields, input fields, etc., in a user interface for the software applications 242. The operating system code 240, code for specific device applications 242, or code components thereof may be temporarily loaded into a volatile storage medium such as the RAM 220 during operation of the mobile electronic device 200. Received communication signals and other data with information may also be stored in the RAM 220.

The stored program control (i.e., software applications 242) for the microprocessor 216 also includes a predetermined set of applications or code components or software modules that control basic device operations, for example, data and voice communication related applications such as the global push client module 248, which are normally installed on the mobile electronic device 200 as the software applications 242 during the manufacturing process. Further applications may also be loaded (i.e., downloaded) onto the mobile electronic device 200 through the operation of networks described above for FIG. 1, the auxiliary I/O subsystem 222, the serial port 224, or the short-range communications subsystem 232. The downloaded code module or components are then installed by the user (or automatically) in the RAM 220 or the non-volatile program memory (e.g., the flash memory 218).

The serial port 224 comprises a USB type interface port for interfacing or synchronizing with another device, such as, a desktop computer (not shown). The serial port 224 is used to set preferences through an external device or software application. The serial port 224 is also used to extend the capabilities of the mobile electronic device 200 by providing for information or software downloads, including user interface information, to the mobile electronic device 200 other than through a wireless communication network, described above for FIG. 1.

Reference is next made to FIG. 3 which shows in block diagram form one embodiment of a network architecture or configuration 300 for pushing information from a source device to an available destination device in accordance with one embodiment. The network 300 includes the mobile electronic device 200 having the global push client 248. The mobile electronic device 200 communicates with a network 312 having a global push server 314 using a network connection 316. In one embodiment, the network connection 316 comprises the wireless WAN 102, the WLAN 104, or the other connection 106, shown in FIG. 1. However, the network connection 316 may be any suitable connection to interface the mobile electronic device 200 with the global push server 314. The global push server 314 either comprises a number of servers or has a number of software modules or components installed thereon and interacting with each other for controlling delivery of data supplied by the global push client 248 to a destination device. The servers or software modules of the global push server 314 include a delivery module 318, a presence module 320, a preference and data module 322, and a translation module 324. The global push server 314 is connected to a number of networks responsible for the delivery of data, indicated by references 324 and individually indicated as 324a, 324b, . . . , 324n, using respective connections 326, individually indicated as 326a, 326b, . . . , 326n. The networks 324 ultimately provide service to a number of electronic communications devices 328, individually indicated as 328a, 328b, 328n, by way of respective connections 330, individually indicated as 330a, 330b, . . . , 330n. The networks 324 are responsible for delivering data to the respective electronic communication devices 328.

In one embodiment, the device 328a is a mobile device such as a personal digital assistant (PDA) offering wireless email services (e.g., such as the mobile electronic device 248) and serviced by the respective mobile device delivery network 324a, the device 328b is a cellular phone serviced by the respective mobile device cellular network 324b, and the device 328n is an office PC running an instant messenger (IM) application and serviced by the respective IM service network 324n. In this embodiment, the connection 330a is a wireless network gateway and associated transceivers, the connection 330b is a wireless cellular network gateway and associated transceivers, and the connection 330n is an enterprise network and/or the Internet providing connectivity between the IM service network 324n and the office PC running the IM application 328n. For the purposes of the following examples, all of the devices 328 are owned or used by a single user, referred to as user A. The mobile electronic device 200 is owned by a different user, referred to as user B.

User B having the mobile electronic device 200 uses the global push client 248 to send data (e.g., messages) to the devices 328 belonging to user A. User B having the global push client 248 typically has his identity preconfigured with the global push server 314 either at the time that the mobile electronic device 200 is acquired and commissioned by user B or when the global push client 248 is installed on the mobile electronic device 200 and configured to work in conjunction with the global push server 314. The preference and data module 322 stores contact information related to users of the global push server 314 (e.g., all users such as user B who have the global push clients 248 and/or other mobile devices similar to the mobile devices 328) such as the various ways in which the users may be contacted, including email addresses, telephone numbers, IM destination addresses, facsimile numbers, pager numbers, etc. The preference and data module 322 also stores prioritization rules for the devices 328 that prioritizes how the user wishes to be contacted at any given time. The prioritization rules entered by users such as user B may prioritize the devices differently, depending on the time of day of an incoming message, etc. The prioritization rules may be updated by the user B using the global push client 248 or an Internet WEB page that is set up to grant user B access to his configuration settings stored in the preference and data module 322. The prioritization rules may be defined in any suitable way, according to the principles of data prioritization and determination known by those skilled in the art. In one embodiment, the preference and data module 322 also functions as a service mediator, choosing between various available services and/or mediums when multiple services are available, or multiple mediums are available over a particular service. The service mediation role of the preference and data module 322 may be fully configurable with preference data and/or other rules, such as bandwidth usage maximization. A user is not required to have a global push client 248 in order to create an account in the preference and data module 322 and enter his contact information and define prioritization rules for the devices specified in the contact information. User A may also have a pre-configured profile stored in the preference and data module 322, although this is not required. User B, when electing to send information to user A, may either select user A's pre-existing profile that was completed by user A or user B may create a tentative profile for user A on the fly that includes at least some of user A's contact information. If user B creates a tentative profile for user A, user B may either create tentative prioritization rules for user A or create no prioritization rules for user A. Alternatively, when user B creates a tentative profile for user A, the global push server 314 may contact user A prompting user A to complete additional contact information and define prioritization rules to be stored in the preference and data module 322.

User B begins the process of sending data to user A by selecting, within the global push client 248, user A as a destination for the data user B will either enter into the global push client 248 or select on the mobile electronic device 200, if the data user B wishes to send to user A is already saved on the mobile electronic device 200. In one embodiment, user B makes an implicit choice as to the medium user B prefers to use for the communication, by either providing a voice message by speaking into a microphone of the mobile electronic device 200 or by entering text using a keyboard or input device of the mobile electronic device 200. In another embodiment, user B makes an explicit choice as to the medium user B prefers to use for the communication by entering data in one medium (e.g., either text or voice) and by selecting delivery using another medium. User B completes the data entry and/or selection and chooses to send the data to user A. The global push client 248 then forwards this information on to the global push server 314 using the network connection 316.

When the global push server 314 receives data destined for one of the mobile devices 328, the presence module 320 of the global push server 314 retrieves the statuses of the devices 328 used by user A from the networks 324 over respective connections 326 and determines how user A is currently accessible. For example, user B may have entered a text message destined for user A, the mobile device 328a may be currently unavailable, but the cellular phone 328b and the IM application on the PC 328n may be currently available. The delivery module 318 retrieves the presence data relating to user A provided by the presence module 320 and determines that user A is currently only available via the devices 328b and 328n. The delivery module 318 next retrieves any preference data related to user A from the preference and data module 322. Alternatively, if the user A previously had no profile stored in the preference and data module 322 and user B supplied a tentative profile for user A, a record is created for user A and preference data is then stored in the preference and data module 322. The delivery module 318 then determines which of the available mobile devices 328 is the highest priority delivery avenue based on any prioritization rules supplied. If the highest priority delivery device between the available cell phone 328b and the IM application 328n is the cell phone 328b, the delivery module 318 next sends the text message to the translation module 324 to translate the message from text to voice, if it is preferred, as determined by the preference and data module 322, to deliver the message via either an automated telephone call or voice message. Alternatively, the text message could be delivered to the cell phone 328b using either SMS or MMS. If a voice message is preferred, once the translation module delivers the translated message back to the delivery module 318, the delivery module 318 sends the translated voice message to the cellular phone 328b using the mobile device cellular network 324b. An SMS or MMS text message would be delivered to the cellular phone 328b using the same delivery route, i.e., using the mobile device cellular network 324b. If the highest priority delivery device between the cell phone 328b and the IM application 328n is the IM application 328n, the delivery module 318 does not have to translate the text message for delivery. The delivery module 318 logs into the IM service server 324n using a suitable login and delivers the text message to the IM application 328n. In one embodiment, the delivery module 318 has its own login for the IM service server 324n and delivers the text message to the user A with identifying information showing that the message was delivered from the delivery module 318 account but originating from the user B. In another embodiment, the preference and data module 322 includes information containing user B's login information for the IM service server 324n and the delivery module 318 logs into the IM service server 324n using user B's login, if user B had configured the preference and data module 322 with the login, password, and authority to do so. The system 300 also has the ability to facilitate bi-directional communications such as the delivery of a response tendered by one of the mobile devices 328 back to the global push client 248.

Reference is next made to FIG. 4 which shows in flow chart form a method 400 for pushing information from a source device (e.g., the global push client 248 of the mobile electronic device 200 used by user B, shown in FIG. 3) to an available destination (erg., any of the devices 328 used by user A) in accordance with one embodiment. At a first step 412, the user, such as user B, enters target client information, such as a user ID for user A, and data to be sent to user A into the global push client. The global push client then checks to see if the target client ID is saved locally on the mobile electronic device (step 414). If the target client ID is present on the mobile electronic device, the target client ID and the entered data is sent to a global push server, such as the global push server 314 (step 416). If the target client ID is not found, the global push client queries the global push server preference and data module, such as the module 322 (step 418), to see if the user A is already registered and has already provided a profile prioritizing the delivery of data to his devices (step 420). The global push server returns the results of the query to the global push client and prompts user B to enter user A's contact information if the user A is not already registered in the preference and data module (step 422). At this point user B may also provide a tentative profile prioritizing the devices associated with user A. If a client profile for user A was found at the step 420, the step 422 is skipped. Next the target client ID (or user information for new target clients) and data is sent to the global push server (step 416). Next, the global push server (e.g., as coordinated by the delivery module 318) retrieves the preference data, for example, from the preference and data module 322 (step 424). The preference data comprises preferences as to delivery priorities pertaining to the user A's mobile devices, such as the devices 328, established by the user A and/or the user B. Next, the global push server retrieves the presence data, for example, from the presence module 320 (step 426). The presence data contains information such as which of the mobile devices 328 are currently available for contacting the user A. The order of the steps 424 and 426 is unimportant and can be performed interchangeably or simultaneously. Once the global push server has the preference data and the presence data, the global push server decides the method of delivery at a step 428 (e.g., which of the devices 328 to use to contact the user A based on which of the devices 328 are currently available and which of the devices 328 that are currently available is at the top of the priority list). Once the global push server has determined the method of delivery to be used, for example which of the devices 328 to use, the global push server determines if any data translation is needed and performs and required data translation using, for example, the translation module 324 (step 430). Data translation is needed when the data is presented to the global push server by the global push client in a medium which is not the same as the medium of the device to which the data is to be delivered. In one example, a voice message may be presented to the global push server but delivery may be to an email application running on a PC. In this case, the translation module could translate the voice message into a text message using a voice recognition component and send the message as text within an email. Alternatively, no translation could be used and the voice message could be sent as an audio attachment to the email. The decision between whether to deliver the message as text or voice (e.g., service selection) is made by a service mediation function of the preference and data module 322, which may be based on preference data or other factors such as bandwidth efficiency, etc. Finally, at a step 432, the data is sent and delivered to the elected device 328 using the respective network 324.

The system 300 for pushing information from a source device to an available destination device combines a service independent interface or unified user interface (e.g., the global push client 248) at the client level and service mediation functionality at a server (e.g., the global push server 314). The system 300 provides for the interoperability of different data exchange formats such as instant messaging, email, fax, phone, etc. When using the global push client 248, a user may send messages to or communicate with other users, who may or may not have the global push client 248, via a priority, preference, and availability based destined service. The global push client 248 serves to achieve a unified user experience where the client 248 is not a specialized application for a specific service, but is a generic client that provides data to any desired destination device of a particular selected user by providing the contact information of the desired client device to the preference and data module 322, if such contact information is not already saved in the preference and data module 322. The global push server 314 determines the available resources for a particular user such as services, networks and devices, and serves to guarantee service availability with the destined users via the available resources. The presence module 320 of the global push server 314 checks the availability of a particular destination device 328 before activating an associated service for the destined user, enabling the system 300 to improve the connectivity to or availability of the destined users. Additionally, service reliability and network performance is enhanced since the system 300 reduces access failures or attempts to communicate with unavailable devices. As a result, the system 300 improves service reliability and network performance as less bandwidth is wasted on failed communication attempts. The global push client 248 also serves to achieve quick and low cost service deployment. Since the global push client 248 is abstracted from the underlying services running on the global push server 314, a new service deployment or a change of existing services related to the use of the global push client 248 and being used on the mobile electronic devices 200 do not need anything other than a software update to the underlying services running on the global push server 314.

Providing a unified user interface such as the global push client 248 is desirable, particularly with services provided over wired and wireless IP networks, where the most growth is currently occurring. Because a user has many ways to contact others through a multitude of services and via several networks and devices, the complexity of organizational communications has increased and the usability and the accessibility of organizational communications has begun to decrease. Additionally, service and network reliability issues can hinder organizational communications since a user may be inaccessible via one medium, unbeknownst to his colleagues, when the user is accessible via another medium. One embodiment of the system 300 serves to create a unified user experience that integrates with and enables other legacy or new services to be reachable along with existing services using the global push client 248 regardless of media type, service, devices, and networks required or involved. Providing a global push client 248 also addresses the issue of resource limitations on mobile electronic devices (e.g., memory size) such as the mobile electronic device 200. Since mobile electronic devices typically have a limited memory size that limits the number of client applications that may run concurrently, the use of the global push client 248 conserves memory or allows for other client applications to be run at the same time since fewer client applications are needed. Since the global push client 248 is able to handle diverse destination services through a unified connection (i.e., the connection 316, shown in FIG. 3) with the global push server 314, the mobile electronic device does not need many embedded client applications or interfaces and the various client service enabling applications, such as service level protocol stacks, may be removed. Therefore, the mobile electronic device implementing one or more of the embodiments described above needs less memory and may be lighter than conventional mobile devices.

The system 300 is operable under a number of different configurations. In one embodiment, the global push client 248 may be installed on any computing device such as a personal digital assistant (PDA), personal computer (PC) or cellular phone. A device having the global push client 248 may also function as one of the mobile devices 328 (i.e., as a destination device). In this case, the mobile device delivery network 324 may not be needed for some destination devices enabled with the global push client 248 and the connection between these devices with the global push server 314 may be similar to the network connection 316. Communications through the system 300 may occur bidirectionally. Additionally, return communication from the mobile devices 328 destined for the mobile electronic device 200 may also be subject to prioritization, such as in the case where the mobile electronic device 200 is no longer available when a return communication destined for the mobile electronic device 200 arrives at the global push server 314. Such reverse prioritization and availability of alternative delivery means is available because the global push server 314 will typically have a user profile for the user of the global push client 248 stored in the preference and data module 322.

The above-described embodiments of the present application are intended to be examples only. Alterations, modifications and variations may be effected to the particular embodiments by those skilled in the art without departing from the scope of the application, which is defined by the claims appended hereto.

What is claimed is:

1. A system for use with a source device that accepts data from a user, the system for pushing the data from the source device to one of a plurality of destination devices used by a target user and accessible to the system, the system comprising:
a push server component communicating with the source device over a first network connection and communicable with the plurality of destination devices over respective second networks, the global push server component having a number of modules including:
a delivery module for coordinating delivery of the data to one of the plurality of destination devices that is available for receiving the data;
a presence module interfacing with the delivery module for retrieving over the respective second networks presence information about the plurality of destination devices and informing the delivery module which of the destination devices is available for receiving the data;
a preference and data module interfacing with the delivery module for storing delivery prioritization data for the plurality of destination devices and informing the delivery module of a predetermined delivery prioritization for the plurality of destination devices; and
a translation module interfacing with the delivery module for translating the data into a form receivable by a selected one of the plurality of destination devices.

2. The system according to claim 1, further comprising:
a global push client module for use with the source device, the global push client module for accepting the data supplied by the user to be sent to the global push server component over the first network connection.

3. The system according to claim 2, wherein the plurality of destination devices are selected from the group consisting of a wireless email enabled mobile device, a cellular phone, an instant messenger application running on a personal computer, an instant messenger application running on a mobile device, a multimedia enabled electronic device, a voice enabled electronic device, a personal computer, a facsimile machine, and a telephone.

4. The system according to claim 1, wherein each of the respective second networks includes:
a service provider network responsible for providing connectivity with the respective destination device;
a network connection connecting the global push server component with the respective service provider network; and
a communications connection between the service provider network of the respective destination device and the respective destination device.

5. The system according to claim 2, wherein the source device is a wireless mobile electronic device and the data provided to the source device for delivery to one of the plurality of destination devices is selected from the group consisting of a voice message and a text message.

6. The system according to claim 2, wherein the predetermined delivery prioritization is a set of rules prioritizing the plurality of destination devices for data delivery, the rules being defined in advance by the user of plurality of destination devices.

7. The system according to claim 2, wherein the predetermined delivery prioritization is a set of rules prioritizing the plurality of destination devices for data delivery, the rules being defined in advance by the user of the source device when the user requests that the data be sent to the push server component.

8. The system according to claim 2, wherein one of the plurality of destination devices comprises an instant messenger application running on a computing device and the delivery module logs into an instant messenger service provided by a service provider of the instant messenger service using login data saved in the preference and data module and sends the data to the instant messenger application.

9. The system according to claim 8, wherein the login data is provided by the user of the source device.

10. The system according to claim 8, wherein the global push server component has a unique login ID saved as the login data and the user is identified as the originating user sending the data.

11. A method of delivering data from a source device to one of a plurality of destination devices comprising:
accepting identification information for a user of the plurality of destination devices and accepting data to be sent to the user;
transferring the user identification information and the data to a server responsible for delivering the data to the user;
retrieving preference data defining prioritization rules for the delivery of the data to one of the plurality of destination devices;
retrieving presence data reporting the availability of each of the plurality of destination devices for receiving the data;
selecting which of the plurality of destination devices to deliver the data to based on the presence data and the preference data; and
delivering the data to the selected destination device.

12. The method according to claim 11, further comprising the steps of, before the step of delivering the data:
determining if the preferred data format of the selected destination device is different from the data format of the data accepted from the user; and
translating the data into the preferred format of the selected destination device if the preferred data format to be received by the selected destination device is different from the data format of the data accepted from the user.

13. The method according to claim 12, wherein the data format is selected from the group consisting of a typed text message and a recorded voice message.

14. The method according to claim 12, further comprising the steps of, before the step of transferring the user identification and the data to a server:
querying the server responsible for delivering the data to the user to see if the identification information and the preference data for the user exists; and
accepting tentative identification information and preference data for the user to be stored on the server responsible for delivering the data to the user.
